(19) United States
(12) Patent Application Publication
(10) Pub. No.: US 2025/0147740 A1
(43) Pub. Date: May 8, 2025

(54) Method of Compiling Neural Network Model, Compiler, and Storage Medium

(71) Applicants: VeriSilicon Microelectronics (Beijing) Co., Ltd., Beijing (CN); VeriSilicon Microelectronics (Shanghai) Co., Ltd., Shanghai (CN); Verisilicon Microelectronics (Nanjing) Co., Ltd., Nanjing (CN); Verisilicon Technology (Shanghai) Co., Ltd., Shanghai (CN); Verisilicon Microelectronics (Hainan) Co., Ltd., Haikou (CN); Verisilicon Microelectronics (Chengdu) Co., Ltd., Chengdu (CN)

(72) Inventor: Yang Zhang, Beijing (CN)

(21) Appl. No.: 18/823,421

(22) Filed: Sep. 3, 2024

(30) Foreign Application Priority Data
Nov. 8, 2023 (CN) 2023114819510

(51) Int. Cl. G06F 8/41

(52) U.S. Cl. CPC G06F 8/41

(57) ABSTRACT

Provided are a method of compiling a neural network model, a compiler, and a computer-readable storage medium. The method of compiling a neural network model includes reading a target neural network model and obtaining the target accelerator info; generating a first directed graph corresponding to the target neural network by using operation elements as nodes and dependencies between the operation elements as edges, wherein the operation elements include operation types and accompanying parameters of the operation types; revising the first directed graph based on a software and hardware information supported by the target accelerator to generate a second directed graph; and generating a compilation result of the target neural network model based on the second directed graph.

### CROSS-REFERENCE TO RELATED APPLICATION

The present disclosure claims the priority to the Chinese patent application with the filing No. 2023114819510 filed with the Chinese Patent Office on Nov. 8, 2023, and entitled “METHOD OF COMPILING NEURAL NETWORK MODEL, COMPILER, AND STORAGE MEDIUM”, the contents of which are incorporated herein by reference in entirety.

### TECHNICAL FIELD

The present disclosure relates to the field of neural networks, and specifically to a method of compiling a neural network model, a compiler, and a computer-readable storage medium.

### BACKGROUND ART

Currently, in the field of Artificial Intelligence (AI), related technology is advancing rapidly. Deep neural networks, which are suitable for complex tasks such as recognition, detection, and tracking, are applied across various industries. In order to deploy AI algorithms at the edge end and achieve terminal-cloud collaboration, the technology of embedded neural network processors is rapidly developing. Due to the excellent performance of neural networks in numerous applications, their terminal applications have become a hot topic in both academia and the market. Moreover, the low power consumption required for terminals has triggered the development of specialized chips for neural networks.

When applying neural network models in accelerators, the neural network models need to undergo compilation by a compiler. However, the current compilation process needs firstly to convert the neural network model into a specific neural network exchange format, and after compilation, a specific importer must be applied to generate the compilation results which can be recognized by the accelerators. This process is complex and leads to lower efficiency in compiling neural network models.

### SUMMARY

The objective of the present disclosure is to provide a method of compiling a neural network model, a compiler, and a computer-readable storage medium, which can enhance the compilation efficiency of neural network models.

In a first aspect, the embodiments of the present disclosure provide a method of compiling a neural network model, comprising reading a target neural network model and obtaining the target accelerator info; generating a first directed graph corresponding to the target neural network by using operation elements as nodes and dependencies between the operation elements as edges, wherein the operation elements comprise operation types and accompanying parameters of the operation types; revising the first directed graph based on a software and hardware information supported by the target accelerator to generate a second directed graph; and generating a compilation result of the target neural network model based on the second directed graph.

In the method of compiling a neural network model provided by the embodiments of the present disclosure, in the process of compiling the target neural network model, after generating a first directed graph corresponding to the target neural network, the produced first directed graph is revised according to the software and hardware information supported by the target accelerator, and the compilation result of the target neural network model is generated according to the second directed graph obtained from the revision of the first directed graph. As the second directed graph is revised based on the software and hardware information supported by the target accelerator, the compilation result obtained from compiling the second directed graph can be directly applied to the target accelerator, wherein the compilation result can be applied directly to the target accelerator without any further special processing so as to improve the compilation efficiency of neural network models.

In the optional embodiments, before the step of revising the first directed graph based on a software and hardware information supported by the target accelerator, the method of compiling a neural network model further comprises optimizing the first directed graph; the step of revising the first directed graph based on a software and hardware information supported by the target accelerator comprises revising the optimized first directed graph based on the software and hardware information supported by the target accelerator; the step of optimizing the first directed graph comprises obtaining completely identical first subgraph and second subgraph from the first directed graph, wherein both the first subgraph and second subgraph comprise multiple nodes and edges; and converting the first subgraph and second subgraph into subgraph nodes. By converting the first subgraph and second subgraph, which are identical in the first directed graph and comprise multiple nodes and edges, into subgraph nodes, multiple nodes and edges are simplified into a single subgraph node. This reduces the number of nodes in the first directed graph and simplifies the structure of the first directed graph. When revising the optimized first directed graph based on the software and hardware information supported by the target accelerator, the efficiency of revising the optimized and structurally simpler first directed graph is also higher.

In the optional embodiments, the step of optimizing the first directed graph further comprises obtaining an extended API for the target accelerator (application programming interface), wherein the extended API comprises multiple target functions; and associating the nodes and the target functions having the same functionalities. Associating in advance the target functions in the extended API of the target accelerator with the nodes in the first directed graph based on the functionalities can enhance the efficiency of the revision when the optimized first directed graph is subsequently revised based on the software and hardware information supported by the target accelerator.

In the optional embodiments, the step of associating the nodes and the target functions having the same functionalities comprises: splitting a single node that can achieve multiple functions; or merging multiple nodes that can achieve a single function; or splitting a single node that can achieve multiple functions and merging multiple nodes that can achieve a single function, so to obtain new nodes. Splitting single node and merging multiple nodes based on functionality can allow each node to be associated with a single target function.

In the optional embodiments, the step of optimizing the first directed graph further comprises converting a precision of the accompanying parameters in each node. Converting the precision of accompanying parameters in each node can allow for adaptation to different requirements for data precision in various application scenarios, thereby enhancing versatility.

In optional embodiments, the step of revising the first directed graph based on a software and hardware information supported by the target accelerator comprises obtaining a supported storage format of the target accelerator; and modifying the data format of the accompanying parameters to the storage format.

In the optional embodiments, the step of revising the first directed graph based on a software and hardware information supported by the target accelerator comprises obtaining an operation type merging program supported by the target accelerator; and merging the nodes according to the operation type merging program.

In the optional embodiments, the step of generating a compilation result of the target neural network model based on the second directed graph comprises generating a C language code as the compilation result according to an order of the nodes in the second directed graph; or, generating a binary model file as the compilation result based on the order of the nodes in the second directed graph; or, generating both the C language code and the binary model file as the compilation result according to the order of the nodes in the second directed graph.

In a second aspect, the embodiments of the present disclosure provide a compiler of a neural network model, comprising an input module, wherein the input module is configured for reading a target neural network model and obtaining the target accelerator info; a conversion module, wherein the conversion module is configured for generating a first directed graph corresponding to the target neural network by using operation elements as nodes and dependencies between the operation elements as edges, wherein the operation elements comprise operation types and accompanying parameters of the operation types; a revision module, wherein the revision module is configured for revising the first directed graph based on a software and hardware information supported by the target accelerator to generate a second directed graph; and a compilation module, the compilation module is configured for generating a compilation result of the target neural network model based on the second directed graph.

In the optional embodiments, before the step of revising the first directed graph based on a software and hardware information supported by the target accelerator, the method of compiling a neural network model further comprises: optimizing the first directed graph; the step of revising the first directed graph based on a software and hardware information supported by the target accelerator comprises: revising the optimized first directed graph based on the software and hardware information supported by the target accelerator; and the step of optimizing the first directed graph comprises: obtaining completely identical first subgraph and second subgraph from the first directed graph, wherein both the first subgraph and the second subgraph comprise the multiple nodes and edges; and converting the first subgraph and the second subgraph into subgraph nodes.

In the optional embodiments, the step of optimizing the first directed graph further comprises: obtaining an extended API for the target accelerator, wherein the extended API comprises multiple target functions; and associating the nodes and the target functions having the same functionalities.

In the optional embodiments, the step of associating the nodes and the target functions having the same functionalities comprises: splitting a single node that can achieve multiple functions; or merging multiple nodes that can achieve a single function; or splitting a single node that can achieve multiple functions and merging multiple nodes that can achieve a single function, so to obtain new nodes; and associating the new nodes and the target functions having the same functionalities.

In a third aspect, the embodiments of the present disclosure provide a computer-readable storage medium storing a computer program, wherein the computer program is executed by a processor to implement the above method of compiling a neural network model.

### BRIEF DESCRIPTION OF DRAWINGS

To more clearly illustrate the technical solutions of the embodiments of the present disclosure, the following will briefly introduce the drawings used in the embodiments. It should be understood that the following drawings only show some embodiments of the present disclosure, and therefore they should not be regarded as a limitation on the scope. Those ordinary skilled in the art can also obtain other related drawings based on these drawings without inventive effort.

FIG. 1 is a schematic diagram of a process of a method of compiling a neural network model provided in one of the embodiments of the present disclosure;

FIG. 2 is a schematic diagram of the process of the method of compiling a neural network model provided in one of the embodiments of the present disclosure;

FIG. 3 is a structural schematic diagram of a compiler of a neural network model provided in one of the embodiments of the present disclosure; and

FIG. 4 is a structural schematic diagram of the compiler of a neural network model provided in some other embodiments of the present disclosure.

### DETAILED DESCRIPTION OF EMBODIMENTS

In order to make the objective, technical solution, and advantages of the present disclosure clearer, the following will provide a clear and complete description of the technical solution in the embodiments of the present disclosure, in conjunction with the drawings in the embodiments of the present disclosure. Obviously, the described embodiments are a part of the embodiments of the present disclosure, rather than all embodiments. The components of embodiments of the present disclosure which are generally described and illustrated in the drawings herein can be arranged and designed in a variety of different configurations.

Accordingly, the following detailed description of the embodiments of the present disclosure provided in the drawings is not intended to limit the scope of the claims of the present disclosure to be protected, but merely represents selected embodiments of the present disclosure.

It should be noted that similar numerals and letters denote similar terms in the following drawings so that once an item is defined in one drawing, it does not need to be further discussed in subsequent drawings.

In addition, terms such as “first” and “second”, are only used to distinguish the descriptive and are not to be construed as indicating or implying relative importance.

It should be noted that the features in the embodiments of the present disclosure can be combined with each other without conflict.

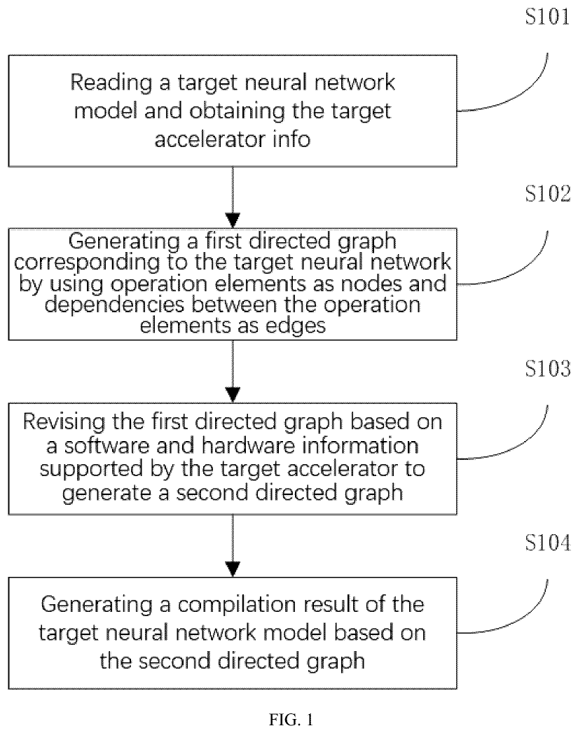

One embodiment of the present disclosure provides a method of compiling a neural network model as shown in FIG. 1, comprising the following steps.

Step S101: reading a target neural network model and obtaining the target accelerator info.

Currently, neural network models require extensive computation during both model training and inference, but they are constrained by the characteristics of their algorithms and the computation itself. Traditional computing chips are no longer sufficient to meet the demands of the computation for the neural network models. Accelerators are needed to accelerate the neural network models and enhance the computational capabilities of the neural network models. In various application scenarios, accelerators need to adhere to different standards. For instance, in the application field of computer vision, accelerators in the application field of computer vision should comply with the OpenVX standard. OpenVX is an open, cross-platform acceleration standard for computer vision applications. It supports performance- and power-optimized computer vision processing, primarily targeting embedded and real-time use cases such as advanced driver assistance systems, facial, body and gesture tracking, intelligent video surveillance, object and scene reconstruction, augmented reality, visual inspection, robotics, etc. OpenVX provides a standardized set of API interfaces, enabling users to develop image processing and computer vision applications on various platforms. These API interface functions can be accessed through online documentation, and OpenVX also offers a wealth of example code for users to reference and learn from. OpenVX supports not only the C++ language but also interfaces for languages like Python, Java, MATLAB/OCTAVE, etc. OpenVX provides a standard set of API interfaces that make it easier for developers to develop computer vision applications with better performance and lower power consumption.

In the step, the target neural network model is the neural network model that needs to run on the target accelerator. The target accelerator is the accelerator on which the target neural network model needs to run. Before running the target neural network model on the target accelerator, the target neural network model needs to be compiled. Therefore, the target neural network model is allowed to meet acceleration standards such as OpenVX so that it can be run on target accelerators following acceleration standards such as Open VX.

Step S102: generating a first directed graph corresponding to the target neural network by using operation elements as nodes and dependencies between the operation elements as edges.

In this step, for the target neural network model, it can be represented in the form of a directed graph, wherein the directed graph is a graphical structure composed of multiple nodes and directed edges. In the embodiments of the present disclosure, the operation elements within the target neural network model can serve as the nodes, and the dependencies between the operation elements can be the edges so as to generate the first directed graph. For example, the operation elements within the target neural network model can be structures such as operators and neural network layers within the target neural network model. The dependencies between the operation elements can be the dependencies between individual operators or the dependencies between various neural network layers.

In addition, in the embodiments of the present disclosure, the operation elements constituting the nodes of the first directed graph can include the operation types as mentioned above, and can also include the accompanying parameters of the operation types. For example, when the operators within the target neural network model are nodes, the accompanying parameters can be specific numerical values, preset constants, and the like for each operator. When the neural network layers are served as nodes, the accompanying parameters can be, for example, the parameters of the layer structure in the neural network layers. In different embodiments of the present disclosure, the accompanying parameters can vary flexibly based on the different operation elements serving as nodes.

Step S103: revising the first directed graph based on a software and hardware information supported by the target accelerator to generate a second directed graph.

Specifically, in this step, the first directed graph can be revised based on the different software and hardware information supported by the target accelerator. For example, in some embodiments of the present disclosure, the different software and hardware information supported by the target accelerator can include operation type merging programs supported by the target accelerator. The operation type merging program combines multiple different software and hardware operations. Each distinct software and hardware operation corresponds to nodes within the first directed graph representing different functionalities. During the revision process of the first directed graph corresponding to the operation type merging programs, the nodes in the first directed graph can be merged accordingly. For example, if the library and hardware support convolution operations when the target accelerator is running, a rectified linear activation operation function, such as the ReLU (rectified linear unit), is performed for the activation operation. The ReLU function is a commonly used activation function in artificial neural networks, typically referring to non-linear functions represented by the slope function and its variations. In neural networks, the ReLU function, which serves as the activation function for neurons and defines the non-linear output results of the neurons after linear transformation, is executed after merging, and the nodes corresponding to convolution operations and the nodes corresponding to rectified linear activation operations can be merged in the first directed graph. This forms a single new node corresponding to the use of rectified linear activation operations immediately after the convolution operations.

It can be understood that, as mentioned above, the step of obtaining an operation type merging program supported by the target accelerator; and merging the nodes according to the operation type merging program, is only an illustrative example of some embodiments of the present disclosure. In some other embodiments of the present disclosure, the software and hardware information supported by the target accelerator can, for example, also comprise a storage format supported by the target accelerator. In this case, the revision of the first directed graph based on the software and hardware information supported by the target accelerator is to modify the data format of the accompanying parameters in the individual nodes to a storage format. Alternatively, in some other embodiments of the present disclosure, it can also be based on other software and hardware information supported by the target accelerator to make corresponding revisions to the first directed graph. It can also involve simultaneously using multiple different software and hardware information supported by the target accelerator to perform multiple different revision operations on the first directed graph, thus resulting in the revised directed graph as the second directed graph. Specific adjustments can be made flexibly according to actual needs.

Step S104: generating a compilation result of the target neural network model based on the second directed graph.

Specifically, in different embodiments of the present disclosure, different compilation operations can be performed on the second directed graph based on different needs for compilation results. For example, in some embodiments of the present disclosure, the compilation result generated according to the second directed graph can be a C language code executable by the target accelerator. In some other embodiments of the present disclosure, the compilation result generated according to the second directed graph can be a binary model file executable by the target accelerator. Alternatively, in some other embodiments of the present disclosure, the compilation result generated according to the second directed graph can include the C language code, the binary model file, and the like that can be executed by the target accelerator. Specific adjustments can be made flexibly according to actual needs. In the case where the compilation result generated by the second directed graph includes the C language code that can be executed by the target accelerator, individual nodes can be compiled sequentially according to the order of the individual nodes in the second directed graph to generate corresponding C language code. Compiling the individual nodes sequentially allows for a smoother execution process of the generated C language code in the target accelerator. Additionally, in the case where the compilation result generated by the second directed graph includes a binary model file that can be executed by the target accelerator, binary instructions and data can be loaded directly onto the target accelerator with which they communicate. This allows for further improvement in the efficiency of executing the binary model files. Subsequently, binary instructions and data files tailored for the specific hardware accelerator can be generated one at a time according to the order of the nodes in the second directed graph.

In the method of compiling a neural network model provided by the embodiments of the present disclosure, in the process of compiling the target neural network model, after generating a first directed graph corresponding to the target neural network, the produced first directed graph is revised according to the software and hardware information supported by the target accelerator, and the compilation result of the target neural network model is generated according to the second directed graph obtained from the revision of the first directed graph. As the second directed graph is revised based on the software and hardware information supported by the target accelerator, the compilation result obtained from compiling the second directed graph can be directly applied to the target accelerator, wherein the compilation results can be applied directly to the target accelerator without any further special processing so as to improve the compilation efficiency of neural network models.

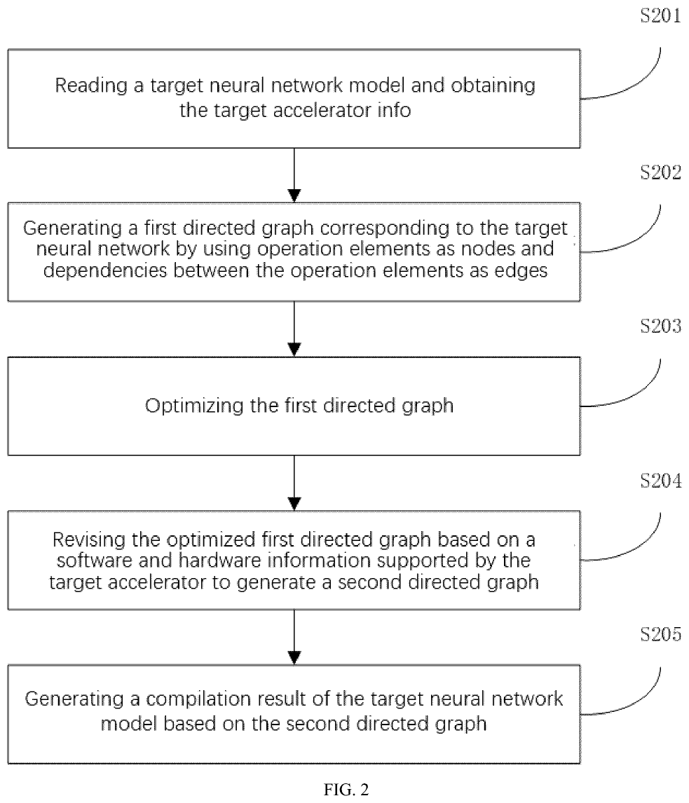

As shown in FIG. 2, another embodiment of the present disclosure provides a method of compiling a neural network model, comprising the following steps.

Step S201: reading a target neural network model and obtaining the target accelerator info.

Step S202: generating a first directed graph corresponding to the target neural network by using operation elements as nodes and dependencies between the operation elements as edges. Step S203: optimizing the first directed graph.

In this step, there are multiple methods for optimizing the first directed graph. In different embodiments of the present disclosure, the first directed graph can be optimized using only one optimization method, or the first directed graph can be optimized using multiple optimization methods simultaneously. Specific adjustments can be made flexibly according to actual needs. Specific optimization methods can, for example, include the following methods.

In the first, in some embodiments of the present disclosure, for example, multiple subgraphs that are identical in the first directed graph can be merged into a single subgraph node. Specifically, it can be as follows: obtaining completely identical first subgraph and second subgraph from the first directed graph, wherein both the first subgraph and second subgraph comprise multiple nodes and edges; and converting the first subgraph and second subgraph into subgraph nodes. It can be understood that in different embodiments of the present disclosure, multiple identical subgraphs can be included in the first directed graph, and the multiple subgraphs can all be merged into a single subgraph node. Taking the part of the first directed graph including “156184356861845231845368618621686423178645231” as an example, in which each digit characterizes multiple distinct nodes in the first directed graph. Within the first directed graph, there are multiple identical “686” and “231”. In this case, the identical “686”, regarded as subgraph nodes, can be merged respectively so as to form a subgraph node A; the identical “231”, regarded as subgraph nodes, can be merged respectively so as to form a subgraph node B. Therefore, the first directed graph is optimized as “15618435A1845B8453A18621A4B78645B”. By converting the first subgraph and second subgraph, which are identical in the first directed graph and comprise multiple nodes and edges, into subgraph nodes, multiple nodes and edges are simplified into a single subgraph node. This reduces the number of nodes in the first directed graph and simplifies the structure of the first directed graph. When revising the optimized first directed graph based on the software and hardware information supported by the target accelerator, the efficiency of revising the optimized and structurally simpler first directed graph is also higher.

In the second, in some embodiments of the present disclosure, the first directed graph can be optimized, for example, by an extended API of the target accelerator. For example, in some embodiments of the present disclosure, an extended API of the target accelerator can be obtained, wherein the extended API comprises multiple target functions. Target functions and nodes that are functionally identical are associated. Associating in advance the target functions in the extended API of the target accelerator with the nodes in the first directed graph based on the functionalities can enhance the efficiency of the revision when the optimized first directed graph is subsequently revised based on the software and hardware information supported by the target accelerator.

In some embodiments of the present disclosure, when associating the target functions and nodes that are functionally identical, there can be a situation in which a node realizes more than one function, or more than one node realizes a single function. Therefore, there will be a situation where one node is associated with multiple target functions or multiple nodes are associated with one target function when associating the target functions and nodes that are functionally identical. At this point, it is possible to split a single node that can achieve multiple functions; or merge multiple nodes that can achieve a single function; or split a single node that can achieve multiple functions and merge multiple nodes that can achieve a single function, so to obtain new nodes; and associate the new nodes and the target functions having the same functionalities. Splitting individual nodes and merging multiple nodes based on functionality can allow each node to be associated with a single target function.

In the third, in some embodiments of the present disclosure, for example, optimization of the first directed graph can be achieved by adjusting the precision of the accompanying parameters for each node. For example, in some embodiments of the present disclosure, it is possible, as required, to convert a precision of the accompanying parameters in each node. Converting the precision of accompanying parameters in each node can allow for adaptation to different requirements for data precision in various application scenarios, thereby enhancing versatility.

It can be understood that the foregoing three methods are only illustrative of specific methods of optimizing the first directed graph in some embodiments of the present disclosure. In practice, there is no restriction that only the three aforementioned methods of optimizing the first directed graph can be used.

Step S204: revising the optimized first directed graph based on a software and hardware information supported by the target accelerator to generate a second directed graph.

Step S205: generating a compilation result of the target neural network model based on the second directed graph.

It is to be understood that steps S201, S202, S204, and S205 in the method of compiling a neural network model provided in the embodiment of the present disclosure are substantially the same as steps S101 to S104 of the preceding embodiment, which can be described with reference to the specific description of the preceding embodiment, and which will not be repeated herein.

In the method of compiling a neural network model provided in this embodiment of the present disclosure, before the step of revising the optimized first directed graph based on a software and hardware information supported by the target accelerator to generate a second directed graph, optimizing the first directed graph first can optimize the compilation process of the target neural network model, so as to get better compilation results.

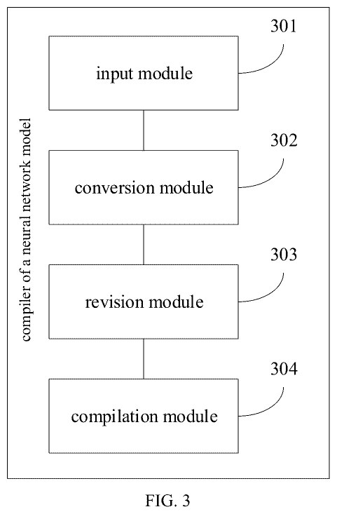

Another embodiment of the present disclosure relates to a compiler of a neural network model, as shown in FIG. 3, comprising an input module 301, wherein the input module 301 is configured for reading a target neural network model and obtaining the target accelerator info; a conversion module 302, wherein the conversion module 302 is configured for generating a first directed graph corresponding to the target neural network by using operation elements as nodes and dependencies between the operation elements as edges, wherein the operation elements comprise operation types and accompanying parameters of the operation types; a revision module 303, wherein the revision module 303 is configured for revising the first directed graph based on a software and hardware information supported by the target accelerator to generate a second directed graph; and a compilation module 304, wherein the compilation module 304 is configured for generating a compilation result of the target neural network model based on the second directed graph.

In the compiler of a neural network model provided in another embodiment of the present disclosure, during the compilation of the target neural network model, The input module 301 first reading a target neural network model and obtaining the target accelerator info. After the conversion module 302 generates the first directed graph corresponding to the target neural network, the revision module 303 revises the first directed graph based on a software and hardware information supported by the target accelerator. The compilation module 304 generates a compilation result of the target neural network model based on the second directed graph obtained from the revision of the first directed graph. As the second directed graph is revised by the compilation module 304 based on the software and hardware information supported by the target accelerator, the compilation result obtained from compiling the second directed graph by the compilation module 304 can be directly applied to the target accelerator, wherein the compilation results can be applied directly to the target accelerator without any further special processing so as to improve the compilation efficiency of neural network models.

Further, in some embodiments of the present disclosure, the step of the revision module 303 revising the first directed graph based on a software and hardware information supported by the target accelerator, comprises obtaining a storage format supported by the target accelerator; and modifying the data format of the accompanying parameters to the storage format.

In other embodiments of the present disclosure, the step of the revision module 303 revising the first directed graph based on a software and hardware information supported by the target accelerator comprises obtaining an operation type merging program supported by the target accelerator; and merging the nodes according to the operation type merging program.

In some embodiments of the present disclosure, the step of the compilation module 304 generating a compilation result of the target neural network model based on the second directed graph comprises generating a C language code as the compilation result according to an order of the nodes in the second directed graph; or, generating a binary model file as the compilation result based on the order of the nodes in the second directed graph; or, generating both the C language code and the binary model file as the compilation result according to the order of the nodes in the second directed graph.

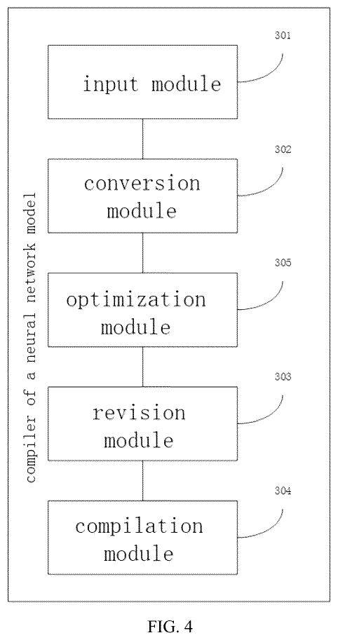

In some embodiments of the present disclosure, as shown in FIG. 4, the compiler of a neural network model can further comprise an optimization module 305, wherein the optimization module 305 is configured for optimizing the first directed graph before the revision module 303 revises the first directed graph based on a software and hardware information supported by the target accelerator. At this time, the revision module 303 can revise the optimized first directed graph based on the software and hardware information supported by the target accelerator.

In some embodiments of the present disclosure, the step of the optimization module 305 optimizing the first directed graph can comprise obtaining completely identical first subgraph and second subgraph from the first directed graph, wherein both the first subgraph and second subgraph comprise multiple nodes and edges; and converting the first subgraph and second subgraph into subgraph nodes.

In some embodiments of the present disclosure, the step of the optimization module 305 optimizing the first directed graph can further comprise obtaining an extended API for the target accelerator, wherein the extended API comprises multiple target functions; and associate the nodes and the target functions having the same functionalities. In addition, the step of the optimization module 305 associating the nodes and the target functions having the same functionalities can include splitting a single node that can achieve multiple functions; or merging multiple nodes that can achieve a single function; or splitting a single node that can achieve multiple functions and merging multiple nodes that can achieve a single function, so to obtain new node; and associating the new nodes and the target functions having the same functionalities.

In some embodiments of the present disclosure, the step of the optimization module 305 optimizing the first directed graph can further comprise converting a precision of the accompanying parameters in each node.

Another embodiment of the present disclosure relates to a computer-readable storage medium storing a computer program. When the computer program is executed by a processor, it implements the above-mentioned method embodiments.

In other words, those skilled in the art can understand that all or some of the steps in the methods of the above embodiments can be completed by instructing the relevant hardware through a program. The program, stored in a storage medium, comprises multiple instructions to enable a device (which can be a microcontroller, chip, etc.) or a processor to execute all or some of the steps of the methods in the various embodiments of the present disclosure The aforementioned storage media include various media that can store program code, such as USB drives, external hard drives, read-only memory (ROM), random access memory (RAM), disks, or optical discs.

The above are just specific embodiments of the present disclosure, but the scope of protection of the present disclosure is not limited to the embodiments. Any variations or substitutions readily apparent to those skilled in the art within the technical scope disclosed in the present disclosure should be encompassed within the scope of protection of the present disclosure. Therefore, the scope of protection of the present disclosure should be determined by the scope of protection of the claims.

What is claimed is:

1. A method of compiling a neural network model, comprising:
reading a target neural network model and obtaining a target accelerator info;
generating a first directed graph corresponding to the target neural network by using operation elements as nodes and dependencies between the operation elements as edges,
wherein the operation elements comprise operation types and accompanying parameters of the operation types;
revising the first directed graph based on a software and hardware information supported by the target accelerator to generate a second directed graph; and
generating a compilation result of the target neural network model based on the second directed graph.

2. The method of compiling a neural network model according to claim 1, wherein before the step of revising the first directed graph based on a software and hardware information supported by the target accelerator, the method of compiling a neural network model further comprises:
optimizing the first directed graph;
the step of revising the first directed graph based on a software and hardware information supported by the target accelerator comprises:
revising the optimized first directed graph based on the software and hardware information supported by the target accelerator; and
the step of optimizing the first directed graph comprises: obtaining a first subgraph and a second subgraph from the first directed graph, wherein the first subgraph and the second subgraph are identical, and wherein both the first subgraph and the second subgraph are comprised of the nodes and edges; and
converting the first subgraph and the second subgraph into subgraph nodes.

3. The method of compiling a neural network model according to claim 2, wherein the step of optimizing the first directed graph further comprises:
obtaining an extended API for the target accelerator, wherein the extended API comprises multiple target functions; and
associating the nodes and the target functions having the same functionalities.

4. The method of compiling a neural network model according to claim 3, wherein the step of associating the nodes and the target functions having the same functionalities comprises:
any of splitting a single node that can achieve multiple functions,
merging multiple nodes that can achieve a single function, and
splitting a single node that can achieve multiple functions and merging multiple nodes that can achieve a single function, so as to obtain new nodes; and
associating the new nodes and the target functions having the same functionalities.

5. The method of compiling a neural network model according to claim 2, wherein the step of optimizing the first directed graph further comprises:
converting a precision of the accompanying parameters in each node.

6. The method of compiling a neural network model according to claim 1, wherein the step of revising the first directed graph based on a software and hardware information supported by the target accelerator comprises:
obtaining a supported storage format of the target accelerator; and
modifying a data format of the accompanying parameters to the storage format.

7. The method of compiling a neural network model according to claim 1, wherein the step of revising the first directed graph based on a software and hardware information supported by the target accelerator comprises:
obtaining an operation type merging program supported by the target accelerator; and
merging the nodes according to the operation type merging program.

8. The method of compiling a neural network model according to claim 1, wherein the step of generating a compilation result of the target neural network model based on the second directed graph comprises any of:
generating a C language code as the compilation result according to an order of the nodes in the second directed graph,
generating a binary model file as the compilation result based on the order of the nodes in the second directed graph and,
generating both the C language code and the binary model file as the compilation result according to the order of the nodes in the second directed graph.

9. A compiler of a neural network model, comprising:
an input module, wherein the input module is configured for reading a target neural network model and obtaining the target accelerator info;
a conversion module, wherein the conversion module is configured for generating a first directed graph corresponding to the target neural network by using operation elements as nodes and dependencies between the operation elements as edges, wherein the operation elements comprise operation types and accompanying parameters of the operation types;
a revision module, wherein the revision module is configured for revising the first directed graph based on a software and hardware information supported by the target accelerator to generate a second directed graph; and
a compilation module, wherein the compilation module is configured for generating a compilation result of the target neural network model based on the second directed graph.

10. A non-transitory computer-readable storage medium, storing a computer program, wherein the computer program is executed by a processor to implement the method of compiling a neural network model according to claim 1.

11. The computer-readable storage medium according to claim 10, wherein before the step of revising the first directed graph based on a software and hardware information supported by the target accelerator, the method of compiling a neural network model further comprises:
optimizing the first directed graph;
the step of revising the first directed graph based on a software and hardware information supported by the target accelerator comprises:
revising the optimized first directed graph based on the software and hardware information supported by the target accelerator; and
the step of optimizing the first directed graph comprises: obtaining a first subgraph and a second subgraph from the first directed graph, wherein the first subgraph and the second subgraph are identical, and wherein both the first subgraph and the second subgraph are comprised of the multiple nodes and edges; and
converting the first subgraph and the second subgraph into subgraph nodes.

12. The computer-readable storage medium according to claim 11, wherein the step of optimizing the first directed graph further comprises:
obtaining an extended API for the target accelerator, wherein the extended API comprises multiple target functions; and
associating the nodes and the target functions having the same functionalities.

13. The computer-readable storage medium according to claim 12, wherein the step of associating the nodes and the target functions having the same functionalities comprises:
any of splitting a single node that can achieve multiple functions,
merging multiple nodes that can achieve a single function, and
splitting a single node that can achieve multiple functions and merging multiple nodes that can achieve a single function, so to obtain new nodes; and
associating the new nodes and the target functions having the same functionalities.

14. The computer-readable storage medium according to claim 11, wherein the step of optimizing the first directed graph further comprises:
converting a precision of the accompanying parameters in each node.

15. The computer-readable storage medium according to claim 10, wherein the step of revising the first directed graph based on a software and hardware information supported by the target accelerator comprises:
obtaining a supported storage format of the target accelerator; and
modifying a data format of the accompanying parameters to the storage format.

16. The computer-readable storage medium according to claim 10, wherein the step of revising the first directed graph based on a software and hardware information supported by the target accelerator comprises:
obtaining an operation type merging program supported by the target accelerator; and
merging the nodes according to the operation type merging program.

17. The computer-readable storage medium according to claim 10, wherein the step of generating a compilation result of the target neural network model based on the second directed graph comprises any of:
generating a C language code as the compilation result according to an order of the nodes in the second directed graph,
generating a binary model file as the compilation result based on the order of the nodes in the second directed graph and,
generating both the C language code and the binary model file as the compilation result according to the order of the nodes in the second directed graph.

18. The compiler of a neural network model according to claim 9, wherein before the step of revising the first directed graph based on a software and hardware information supported by the target accelerator, the method of compiling a neural network model further comprises:
optimizing the first directed graph;
the step of revising the first directed graph based on a software and hardware information supported by the target accelerator comprises:
revising the optimized first directed graph based on the software and hardware information supported by the target accelerator; and
the step of optimizing the first directed graph comprises: obtaining completely identical first subgraph and second subgraph from the first directed graph, wherein both the first subgraph and the second subgraph comprise the multiple nodes and edges; and
converting the first subgraph and the second subgraph into subgraph nodes.

19. The compiler of a neural network model according to claim 18, wherein the step of optimizing the first directed graph further comprises:
obtaining an extended API for the target accelerator, wherein the extended API comprises multiple target functions; and
associating the nodes and the target functions having the same functionalities.

20. The compiler of a neural network model according to claim 19, wherein the step of associating the nodes and the target functions having the same functionalities comprises:
any of splitting a single node that can achieve multiple functions,
merging multiple nodes that can achieve a single function, and
splitting a single node that can achieve multiple functions and merging multiple nodes that can achieve a single function, so to obtain new nodes; and
associating the new nodes and the target functions having the same functionalities.
